(19) United States
(12) Patent Application Publication
(10) Pub. No.: US 2026/0122260 A1
(43) Pub. Date: Apr. 30, 2026

(54) CARRIAGE OF MULTIPLE PARAMETER SETS IN A MEDIA FILE

(71) Applicant: InterDigital VC Holdings, Inc., Wilmington, DE (US)

(72) Inventors: Srinivas Gudumasu, Montreal (CA); Ahmed Hamza, Coquitlam (CA); Gurdeep Bhullar, Montreal (CA); Gaëlle Martin-Cocher, Toronto (CA)

(73) Assignee: InterDigital VC Holdings, Inc., Wilmington, DE (US)

(21) Appl. No.: 18/930,756

(22) Filed: Oct. 29, 2024

(51) Int. Cl. H04N 19/423; H04N 19/169

(52) U.S. Cl. CPC H04N 19/423; H04N 19/188

(57) ABSTRACT

Systems, methods, and instrumentalities are disclosed for the carriage of multiple parameter sets in a media file. A device may include a processor that may be configured to receive a V3C bitstream, the V3C bitstream comprising data associated with a first track and at least a first V3C parameter set and a second V3C parameter set. The device may store the first V3C parameter set in a first SampleEntry instance. The device may store the second V3C parameter set in a second SampleEntry instance. The device may store in a first SampleDescriptionBox associated with the first track, the first SampleEntry instance and the second SampleEntry instance. The device may send the data associated with the first track and the first SampleDescriptionBox.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### BRIEF SUMMARY

Systems, methods, and instrumentalities are disclosed for the carriage of multiple parameter sets in a media file. A device may include a processor that may be configured to receive a V3C bitstream, the V3C bitstream comprising data associated with a first track and at least a first V3C parameter set and a second V3C parameter set. The device may store the first V3C parameter set in a first SampleEntry instance. The device may store the second V3C parameter set in a second SampleEntry instance. The device may store in a first SampleDescriptionBox associated with the first track, the first SampleEntry instance and the second SampleEntry instance. The device may send the data associated with the first track and the first SampleDescriptionBox.

In examples, the first track may be one of a V3C bitstream track, an Atlas track, an Atlas tile track, or V3C video track. The V3C bitstream may include first V3C unit header information and second V3C unit header information. The device may store the first V3C unit header information in the first SampleEntry instance. The device may store the second V3C unit header information in the second SampleEntry instance.

In examples, the data associated with the first track may include samples. The device may store data associating a first plurality of the samples with the first SampleEntry instance. The device may store data associating a second plurality of the samples with the second SampleEntry instance. The device may send the data associating the first plurality of the samples with the first SampleEntry instance. The device may send the data associating the second plurality of the samples with the second SampleEntry instance.

In examples, the data associating the first plurality of the samples with the first SampleEntry instance may include an index value associated with the first SampleEntry instance and the first plurality of samples. The data associating the second plurality of the samples with the second SampleEntry instance may include an index value associated with the second SampleEntry instance and the second plurality of samples.

In examples, the index value associated with the first SampleEntry instance may be a sample description index value. The index value associated with the second SampleEntry instance may be a sample description index value.

A device may receive V3C bitstream, data associated with a first track, and a first SampleDescriptionBox associated with the first track. The device may retrieve from the first SampleDescriptionBox a first SampleEntry instance. The device may retrieve from the first SampleDescriptionBox a second SampleEntry instance. The device may retrieve from the first SampleEntry instance a first V3C parameter set. The device may retrieve from the second SampleEntry instance a second V3C parameter set. The device may render data based on at least the first V3C parameter set and the second V3C parameter set.

In examples, the device may retrieve from the first SampleEntry instance first V3C unit header information. The device may retrieve from the second SampleEntry instance second V3C unit header information. The device may render data based on at least the first V3C parameter set and the second V3C parameter set is further configured to render data based on at least the first V3C parameter set, the second V3C parameter set, the first V3C unit header information, and the second V3C unit header information.

In examples, the data associated with the first track may include samples. The device may retrieve data associating a first plurality of the samples with the first SampleEntry instance. The device may retrieve data associating a second plurality of the samples with the second SampleEntry instance. The data associating the first plurality of the samples with the first SampleEntry instance may include an index value associated with the first SampleEntry instance and the first plurality of samples. The data associating the second plurality of the samples with the second SampleEntry instance may include an index value associated with the second SampleEntry instance and the second plurality of samples.

A device may receive a V3C bitstream, the V3C bitstream comprising data associated with a first track and at least a first V3C parameter set and a second V3C parameter set. The device may store the first V3C parameter set in a first SampleEntry instance. The first SampleEntry may be associated with the first track. The device may store the second V3C parameter set in the first SampleEntry instance. The device may send the data associated with the first track and the first SampleEntry instance.

In examples, the V3C bitstream further may include first V3C unit header information and second V3C unit header information. The device may store the first V3C unit header information in the first SampleEntry instance. The device may store the second V3C unit header information in the first SampleEntry instance.

In examples, the data associated with the first track may include samples. The device may store in the first SampleEntry instance, data associating a first plurality of the samples with the first V3C parameter set and the first V3C header information. The device may store in the first SampleEntry instance data associating a second plurality of the samples with the second V3C parameter set and the second V3C header information.

In examples, the data associating the first plurality of the samples with the first V3C parameter set and the first V3C header information may be associated with a grouping type vvps. The second plurality of the samples with the second V3C parameter set and the second V3C header information may be associated with the grouping type vvps.

In examples, the data associating the first plurality of the samples with the first V3C parameter set and the first V3C header information may include first data stored in a SampleToGroupBox and first data stored in a SampleGroupDescriptionEntry. The data associating the second plurality of the samples with the second V3C parameter set and the second V3C header information may include second data stored in the SampleToGroupBox and second data stored in the SampleGroupDescriptionEntry.

In examples, the first data stored in the SampleToGroupBox may include data associating the first plurality of samples with a first sample group description entry index. The first data in the SampleGroupDescriptionEntry may include data associating the first V3C parameter set and the first V3C header information. The second data stored in the SampleToGroupBox may include data associating the second plurality of samples with a second sample group description entry index. The second data in the SampleGroupDescriptionEntry may include data associating the second V3C parameter set and the second V3C header information.

In examples, the V3C bitstream further may include data associated with a second track. The data associated with the second track may include second samples. The device may store in a second SampleEntry instance associated with the second track, data associating a first plurality of the second samples with the first V3C parameter set and the first V3C header information. The device may store in the second SampleEntry instance, data associating a second plurality of the second samples with the second V3C parameter set and the second V3C header information.

A device may receive V3C bitstream, data associated with a first track, and a first SampleEntry associated with the first track. The device may retrieve from the first SampleEntry a first V3C parameter set and first V3C unit header information. The device may retrieve from the first SampleEntry a second V3C parameter set and second V3C unit header information. The device may render data based on at least the first V3C parameter set and the second V3C parameter set. The data associated with the first track may include samples.

In examples, the device may retrieve from the first SampleEntry instance data associating a first plurality of the samples with the first V3C parameter set and the first V3C header information. The device may retrieve from the first SampleEntry instance data associating a second plurality of the samples with the second V3C parameter set and the second V3C header information. The data associating the first plurality of the samples with the first V3C parameter set and the first V3C header information may be associated with a grouping type vvps. The second plurality of the samples with the second V3C parameter set and the second V3C header information may be associated with the grouping type vvps.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. 3 shows an example video decoder according to one or more embodiments of the present disclosure.

FIG. 4 is a diagram showing an example of a video-based point cloud compression (V-PCC) bitstream structure as a sequence of V-PCC units.

FIG. 5 is a diagram showing an example of tile and tile group partitioning of an atlas frame.

FIG. 6 is a diagram showing an example structure of a multi-track ISOBMFF V-PCC container.

FIG. 7 shows an example of using multiple sample entries in multi-track V3C file.

FIG. 8A shows an example of a V3C ISOBMFF file structure with a single track.

FIG. 8B shows an example of a V3C ISOBMFF file structure with a single atlas track.

FIG. 9 shows an example of using ‘vvps’ sample group in multi-track V3C file.

FIG. 10 shows an example representation of using ‘vvps’ sample group in multi-track V3C file.

FIG. 11 shows an example of using ‘vvps’ sample group in a V3C file with an atlas track and multiple atlas tile tracks.

FIG. 12 shows an example of using ‘vvps’ sample group in a V3C ISOBMFF file with multiple atlases.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

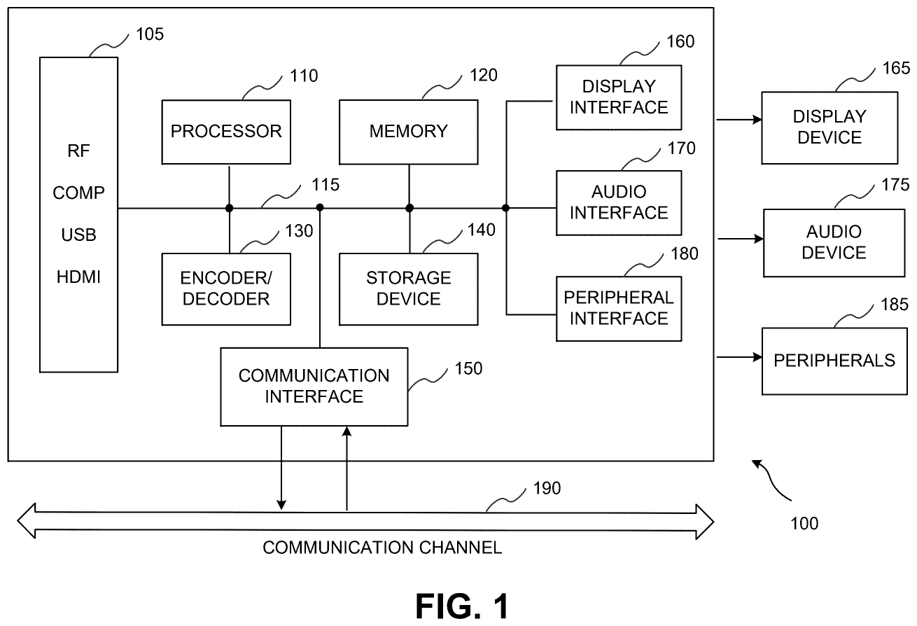

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., I2C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

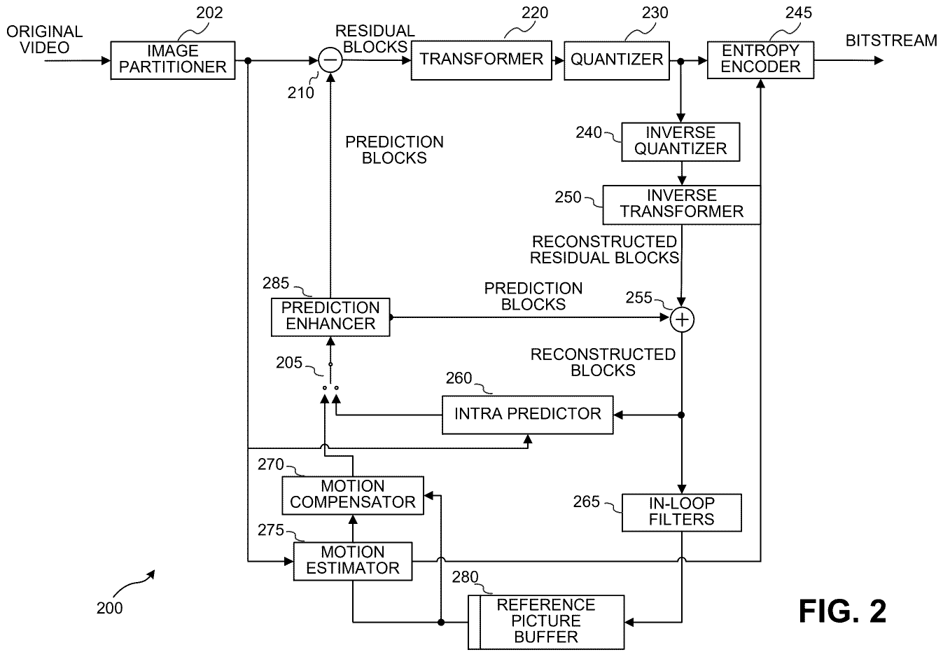

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

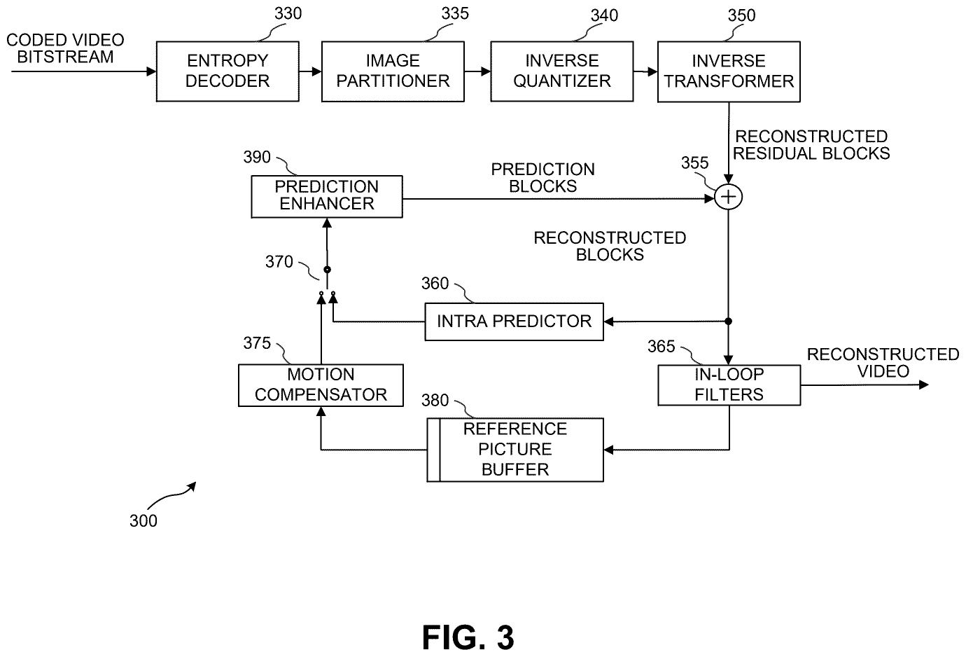

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

Systems, methods, and instrumentalities are disclosed for the carriage of multiple parameter sets in a media file. A device may include a processor that may be configured to receive a V3C bitstream, the V3C bitstream comprising data associated with a first track and at least a first V3C parameter set and a second V3C parameter set. The device may store the first V3C parameter set in a first SampleEntry instance. The device may store the second V3C parameter set in a second SampleEntry instance. The device may store in a first SampleDescriptionBox associated with the first track, the first SampleEntry instance and the second SampleEntry instance. The device may send the data associated with the first track and the first SampleDescriptionBox.

In examples, the first track may be one of a V3C bitstream track, an Atlas track, an Atlas tile track, or V3C video track. The V3C bitstream may include first V3C unit header information and second V3C unit header information. The device may store the first V3C unit header information in the first SampleEntry instance. The device may store the second V3C unit header information in the second SampleEntry instance.

In examples, the data associated with the first track may include samples. The device may store data associating a first plurality of the samples with the first SampleEntry instance. The device may store data associating a second plurality of the samples with the second SampleEntry instance. The device may send the data associating the first plurality of the samples with the first SampleEntry instance. The device may send the data associating the second plurality of the samples with the second SampleEntry instance.

In examples, the data associating the first plurality of the samples with the first SampleEntry instance may include an index value associated with the first SampleEntry instance and the first plurality of samples. The data associating the second plurality of the samples with the second SampleEntry instance may include an index value associated with the second SampleEntry instance and the second plurality of samples.

In examples, the index value associated with the first SampleEntry instance may be a sample description index value. The index value associated with the second SampleEntry instance may be a sample description index value.

A device may receive V3C bitstream, data associated with a first track, and a first SampleDescriptionBox associated with the first track. The device may retrieve from the first SampleDescriptionBox a first SampleEntry instance. The device may retrieve from the second SampleDescriptionBox a second SampleEntry instance. The device may retrieve from the first SampleEntry instance a first V3C parameter set. The device may retrieve from the second SampleEntry instance a second V3C parameter set. The device may render data based on at least the first V3C parameter set and the second V3C parameter set.

In examples, the device may retrieve from the first SampleEntry instance first V3C unit header information. The device may retrieve from the second SampleEntry instance second V3C unit header information. The device may render data based on at least the first V3C parameter set and the second V3C parameter set is further configured to render data based on at least the first V3C parameter set, the second V3C parameter set, the first V3C unit header information, and the second V3C unit header information.

In examples, the data associated with the first track may include samples. The device may retrieve data associating a first plurality of the samples with the first SampleEntry instance. The device may retrieve data associating a second plurality of the samples with the second SampleEntry instance. The data associating the first plurality of the samples with the first SampleEntry instance may include an index value associated with the first SampleEntry instance and the first plurality of samples. The data associating the second plurality of the samples with the second SampleEntry instance may include an index value associated with the second SampleEntry instance and the second plurality of samples.

A device may receive a V3C bitstream, the V3C bitstream comprising data associated with a first track and at least a first V3C parameter set and a second V3C parameter set. The device may store the first V3C parameter set in a first SampleEntry instance. The first SampleEntry may be associated with the first track. The device may store the second V3C parameter set in the first SampleEntry instance. The device may send the data associated with the first track and the first SampleEntry instance.

In examples, the V3C bitstream further may include first V3C unit header information and second V3C unit header information. The device may store the first V3C unit header information in the first SampleEntry instance. The device may store the second V3C unit header information in the first SampleEntry instance.

In examples, the data associated with the first track may include samples. The device may store in the first SampleEntry instance, data associating a first plurality of the samples with the first V3C parameter set and the first V3C header information. The device may store in the first SampleEntry instance data associating a second plurality of the samples with the second V3C parameter set and the second V3C header information.

In examples, the data associating the first plurality of the samples with the first V3C parameter set and the first V3C header information may be associated with a grouping type vvps. The second plurality of the samples with the second V3C parameter set and the second V3C header information may be associated with the grouping type vvps.

In examples, the data associating the first plurality of the samples with the first V3C parameter set and the first V3C header information may include first data stored in a SampleToGroupBox and first data stored in a SampleGroupDescriptionEntry. The data associating the second plurality of the samples with the second V3C parameter set and the second V3C header information may include second data stored in the SampleToGroupBox and second data stored in the SampleGroupDescriptionEntry.

In examples, the first data stored in the SampleToGroupBox may include data associating the first plurality of samples with a first sample group description entry index. The first data in the SampleGroupDescriptionEntry may include data associating with the first V3C parameter set and the first V3C header information. The second data stored in the SampleToGroupBox may include data associating the second plurality of samples with a second sample group description entry index. The second data in the SampleGroupDescriptionEntry may include data associating with the second V3C parameter set and the second V3C header information.

In examples, the V3C bitstream further may include data associated with a second track. The data associated with the second track may include second samples. The device may store in a second SampleEntry instance associated with the second track, data associating a first plurality of the second samples with the first V3C parameter set and the first V3C header information. The device may store in the second SampleEntry instance, data associating a second plurality of the second samples with the second V3C parameter set and the second V3C header information.

A device may receive V3C bitstream, data associated with a first track, and a first SampleEntry associated with the first track. The device may retrieve from the first SampleEntry a first V3C parameter set and first V3C unit header information. The device may retrieve from the first SampleEntry a second V3C parameter set and second V3C unit header information. The device may render data based on at least the first V3C parameter set and the second V3C parameter set. The data associated with the first track may include samples.

In examples, the device may retrieve from the first SampleEntry instance data associating a first plurality of the samples with the first V3C parameter set and the first V3C header information. The device may retrieve from the first SampleEntry instance data associating a second plurality of the samples with the second V3C parameter set and the second V3C header information. The data associating the first plurality of the samples with the first V3C parameter set and the first V3C header information may be associated with a grouping type vvps. The second plurality of the samples with the second V3C parameter set and the second V3C header information may be associated with the grouping type vvps.

High-quality 3D point clouds may be an advanced representation of immersive media. A point cloud may include of a set of points represented in the 3D space using coordinates indicating the location of points (e.g., each point) along with one or more attributes, such as the color associated with each point, transparency, time of acquisition, reflectance of laser, or material property, etc. Point clouds may be captured. For example, one technique for capturing point clouds may be using multiple cameras and/or depth sensors. Light Detection and Ranging (LiDAR) laser scanners may be used for capturing point clouds. The number of points required to (e.g., realistically) reconstruct objects and/or scenes using point clouds may be in the order of millions (e.g., or even billions). Efficient representation and/or compression may be essential for storing and transmitting point cloud data.

In their uncompressed form, volumetric videos may be represented by a large amount of data. Visual Volumetric Video-based Coding (V3C) may leverage the compression efficiency of existing 2D video codecs to reduce the amount of data needed for storage and transmission of volumetric videos. A V3C encoder may convert volumetric frames into a collection of 2D image sequences and associated metadata that enable the reconstruction of the volumetric frames, known as atlas data. The resulting 2D image sequences may be subsequently coded using traditional video or image encoders. The atlas data may be coded with (e.g., similar) mechanisms. V3C may be a generic mechanism for volumetric video coding, and it may be used by different applications targeting volumetric content compression, such as point clouds, immersive videos, and mesh representations of visual volumetric frames. Examples may comprise Video-based Point Cloud Compression (V-PCC) and MPEG Immersive Video (MIV).

The V3C specification may utilize a high-level syntax (HLS) syntax design (e.g., associated with 2D video codecs) to represent the coded atlas data. Coded atlas data may be represented by a sequence of Network Abstraction Layer (NAL) units.

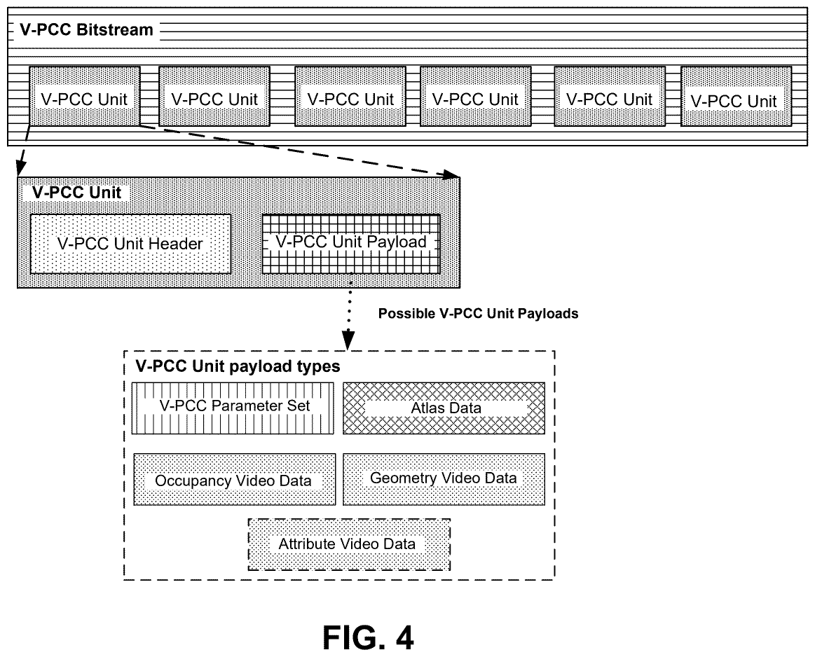

FIG. 4 is a diagram showing an example of a video-based point cloud compression (V-PCC) bitstream structure as a sequence of V-PCC units. A V-PCC bitstream may comprise a sequence of V-PCC units (e.g., as shown by example in FIG. 4). A V-PCC unit (e.g., each V-PCC unit) may have a V-PCC unit header and/or a V-PCC unit payload. A V-PCC unit header may describe a V-PCC unit type. Table 1 shows examples of V-PCC unit types. An attribute video data V-PCC unit header may specify one or more attribute types and/or indices, which may allow multiple instances of the same attribute type to be supported. Table 2 shows examples of V-PCC attribute types. Occupancy, geometry, and/or attribute video data unit payloads (e.g., as shown by example in FIG. 4) may correspond to video data units (e.g., network abstraction layer (NAL) units) that may be decoded by a video decoder. A video decoder corresponding to a video-coded component sub-bitstream (e.g., each video-coded component sub-bitstream such as an occupancy, geometry, and/or attribute sub-stream) may be signaled in a V-PCC parameter set.

TABLE 1
Examples of V-PCC unit types

| vuh_unit_type | Identifier | V-PCC Unit Type | Description |
|---|---|---|---|
| 0 | VPCC_VPS | V-PCC | V-PCC level |
| | | parameter set | parameters |
| 1 | VPCC_AD | Atlas data | Atlas |
| | | | information |
| 2 | VPCC_OVD | Occupancy | Occupancy |
| | | Video Data | information |
| 3 | VPCC_GVD | Geometry | Geometry |
| | | Video Data | information |
| 4 | VPCC_AVD | Attribute | Attribute |
| | | Video Data | information |
| 5 . . . 31 | VPCC_RSVD | Reserved | — |

TABLE 2
Examples of V-PCC attribute types

| ai_attribute_{—} | | |
|---|---|---|
| type_id[j][i] | Identifier | Attribute type |
| 0 | ATTR_TEXTURE | Texture |
| 1 | ATTR_MATERIAL_ID | Material ID |
| 2 | ATTR_TRANSPARENCY | Transparency |
| 3 | ATTR_REFLECTANCE | Reflectance |
| 4 | ATTR_NORMAL | Normals |
| 5 . . . 14 | ATTR_RESERVED | Reserved |
| 15 | ATTR_UNSPECIFIED | Unspecified |

A V-PCC bitstream high-level syntax (HLS) may support, for example, tile groups (e.g., sets of tiles) in one or more atlas frames. An atlas frame may be partitioned into tiles and/or tile groups (e.g., sets of tiles). An atlas frame may be divided, for example, into one or more tile rows and/or one or more tile columns. A tile may be, for example, a rectangular region of an atlas frame. A tile group (e.g., a set of tiles) may include one or more tiles of an atlas frame. Tile(s) in a tile group (e.g., a set of tiles) may be independently decodable. The number of tiles in tile groups may vary.

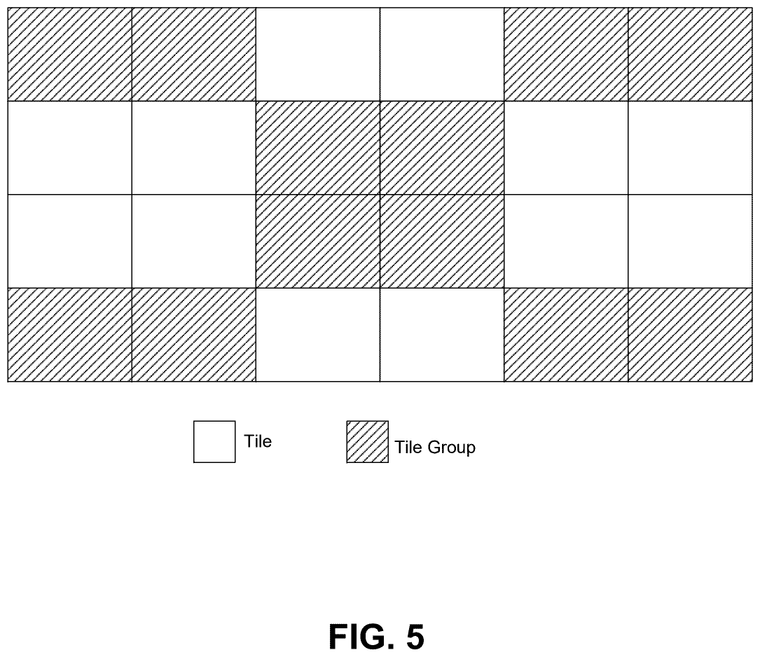

FIG. 5 is a diagram showing an example of tile and tile group partitioning of an atlas frame (e.g., into 24 tiles and nine tile groups). FIG. 5 is shown with alternating shading to distinguish nine tile groups. In examples, rectangular tile group partitioning (e.g., only rectangular tile group partitioning) may be supported. A tile group may include a number of tiles of an atlas frame that collectively form, for example, a rectangular region of the atlas frame (e.g., two or four tiles per tile group as shown by example in FIG. 5). A tile group may include a set of V-PCC tiles associated with an atlas frame.

Supplemental enhancement information (SEI) messages may be signaled in a V-PCC bitstream, for example, to associate patches and/or volumetric shapes (e.g., rectangles) within an atlas frame with objects within a scene represented by a point cloud. SEI messages may enable and/or support annotating, labeling, and/or adding properties to the one or more objects. Objects may correspond to real objects (e.g., physical objects within a scene) and/or conceptual objects (e.g., objects that may relate to physical or other properties). An object may be associated with parameters and/or properties (e.g., different parameters and/or properties), which may, for example, correspond to information (e.g., information provided) during creation and/or editing (e.g., creation and/or editing process(es)) of a point cloud or scene graph. Dependency relationships may be defined between different objects. For example, an object may be part of one or more other objects.

Objects within a point cloud may be persistent in time or may be updated (e.g., at any time and/or frame). Associated information (e.g., information associated with an object) may persist, for example, until being updated or replaced (e.g., by update/association signaling), or until the end of a bitstream. One or more patches and/or 2D volumetric rectangles may be associated with one or more objects. A 2D volumetric rectangle may include one or more patches.

Time-based media may be stored in one or more file formats, such as an ISO Base Media File Format (ISOBMFF). A file in a media file format (e.g., ISOBMFF) may include structural and/or media data information, for example, for timed presentations of media data, such as audio, video, etc. A file format (e.g., ISOBMFF) may support un-timed data for example, meta-data at different levels within a file structure. A logical structure of a file may be, for example, a movie that includes a set of time-parallel tracks. A time structure of a file may be, for example, tracks that include sequences of samples in time. Sequences may be mapped into the timeline of the movie (e.g., overall movie). ISOBMFF may be, for example, based on box-structured files. A box-structured file may include a series of boxes (e.g., atoms), which may have a size and a type. A type (e.g., among multiple types) may be, for example, a 32-bit value. A type may be selected or chosen, for example, to be four printable characters, which may be referred to as a four-character code (4CC). Un-timed data may be included, for example, in a metadata box (e.g., at a file level, or attached to a movie box or a stream of timed data, which may be referred to as tracks, within the movie).

An ISOBMFF container may comprise multiple top-level boxes. For example, a MovieBox (‘moov’) may be a top-level box within an ISOBMFF container. A MovieBox (‘moov’) may include metadata for continuous media streams that may be present in a file. Metadata may be signaled within the hierarchy of boxes in the Movie box, e.g., within a TrackBox (‘trak’). A track may represent a media stream (e.g., a continuous media stream that is present in a file). A media stream may include a sequence of samples (e.g., audio and/or video access units of an elementary media stream). Samples may be enclosed within a MediaDataBox (‘mdat’), which may be present at the top-level of a container. Metadata for a track (e.g., each track) may include, for example, a list of sample description entries. A sample description entry (e.g., each sample description entry) may provide, for example, a coding and/or encapsulation format that may be used in a track and/or may provide initialization data for processing the coding and/or encapsulation format. A sample (e.g., each sample) may be associated with one or more sample description entries of a track. An explicit timeline map may be defined for a track (e.g., each track), which may be referred to as an edit list. An edit list may be signalled, for example, using an EditListBox, which may have the following syntax. A sample description entry entry (e.g., each sample description entry) may define part of a track timeline, for example, by mapping part of a composition timeline, and/or by indicating ‘empty’ time (e.g., portions of a presentation timeline that map to no media, resulting in an ‘empty’ edit).

An example syntax for EditListBox may be provided as follows:

```
aligned(8) class EditListBox extends FullBox(‘elst’, version, flags) {
  unsigned int(32) entry_count;
  for (i=1; i <= entry_count; i++) {
    if (version==1) {
      unsigned int(64) edit_duration;
      int(64) media_time;
    } else { // version==0
      unsigned int(32) edit_duration;
      int(32) media_time;
    }
    int(16) media_rate_integer;
    int(16) media_rate_fraction = 0;
  }
}
```

ISOBMFF may support imposition of one or more actions on a player and/or a renderer. In examples (e.g., for a video stream), a restricted video scheme track may be used to impose one or more actions. For example, post-decoder requirements may be signaled on a video track that is a restricted video scheme track. A track may be transformed into a restricted video scheme track, for example, by setting the track's sample entry code to a four-character code (4CC) (e.g., ‘resv’) and by adding a RestrictedSchemeInfoBox to the track's sample description (e.g., without modifying other boxes). An original sample entry type, which may be based on the video codec used to encode a stream, may be stored within an OriginalFormatBox within the RestrictedSchemeInfoBox. A RestrictedSchemeInfoBox may include one or more boxes (e.g., three boxes such as OriginalFormatBox, SchemeTypeBox, and SchemeInformationBox). An OriginalFormatBox may store an original sample entry type, which may be based on the video codec used to encode a component stream. The nature of a restriction may be defined in the SchemeTypeBox.

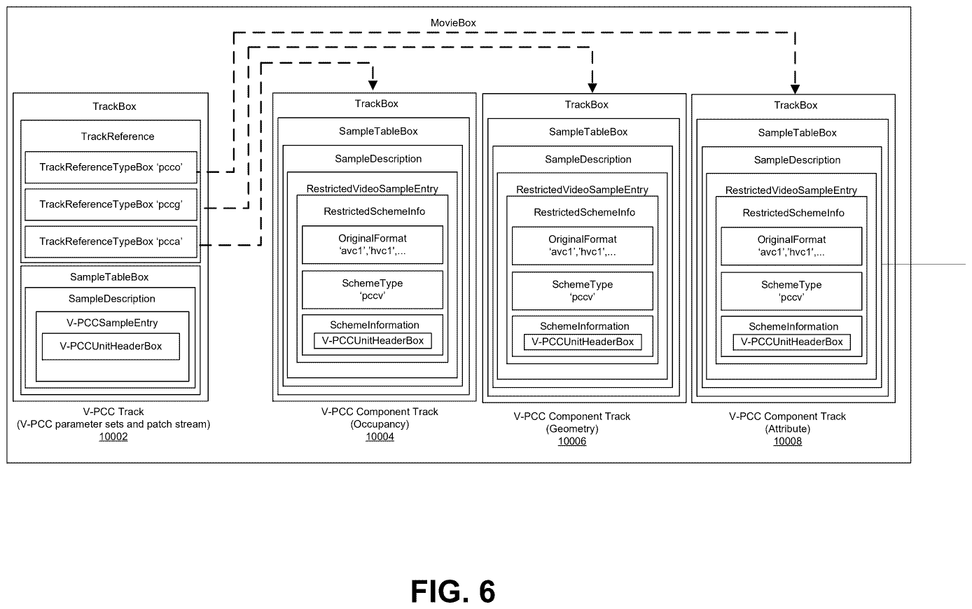

FIG. 6 is a diagram showing an example structure of a multi-track ISOBMFF V-PCC container. In examples, a multi-track V-PCC container may include, for example, one or more of the following. A multi-track V-PCC container may include, for example, a V-PCC track 10002 that includes a V-PCC parameter set and/or atlas sub-bitstream parameter sets (e.g., in the sample entry) and/or samples that may carry atlas sub-bitstream NAL units. V-PCC and VPCC are used interchangeably herein. A track may include track references to other tracks that may, for example, carry payloads of video compressed V-PCC units (e.g., unit types VPCC_OVD, VPCC_GVD, and/or VPCC_AVD). A multi-track V-PCC container may include, for example, a restricted video scheme track, where samples may include access units of a video-coded elementary stream for occupancy map data (e.g., payloads of V-PCC units of type VPCC_OVD). A multi-track V-PCC container may include, for example, one or more restricted video scheme tracks, where samples may include access units of video-coded elementary streams for geometry data e.g., payloads of V-PCC units of type VPCC_GVD). A multi-track V-PCC container may include, for example, zero or more restricted video scheme tracks, where samples may include access units of video-coded elementary streams for attribute data (e.g., payloads of V-PCC units of type VPCC_AVD). A video track, e.g., a restricted video track, may be used to store a V3C bitstream indicating that a process may be (e.g., has to be) performed by the receiver on the corresponding track.

Advancements in capturing and rendering 3D points may be applied to tele-presence, virtual reality, and/or large-scale dynamic 3D maps, for example. A 3D Graphics subgroup may include the development of two 3D point cloud compression (PCC) standards, for example: a geometry-based compression standard for static point clouds and LiDAR captured time-varying sparse point clouds, and a video-based compression standard for dynamic point clouds. Efficient and interoperable storage and transmission of 3D point clouds may be supported. Lossy and/or lossless coding of point cloud geometry coordinates and attributes may be supported.

The carriage specification (e.g., V3C carriage specification) may specify the storage of parameter sets (e.g., V3C parameter sets (VPS)) in V3CDecoderConfigurationRecord. Though the semantics of the V3CDecoderConfigurationRecord may provide the flexibility to include multiple parameter sets (e.g., V3C parameter sets), the specification may restrict the number of parameter sets (e.g., V3C parameter sets) to one. The specification (e.g., V3C specification (ISO/IEC 23090-5) may support signaling of multiple parameter sets (e.g., V3C parameter sets) in a bitstream (e.g., V3C bitstream). If the VPS information is changing (e.g., dynamically) over time in the bitstream (e.g., V3C bitstream), the unit header information (e.g., V3C unit header information) for the following V3C units may change (e.g., dynamically).

In examples, multiple V3C parameter sets and multiple V3C unit headers information may be stored, for example, if/when the V3C parameter sets and/or the V3C header information change over the time in a V3C bitstream. Details may be provided on mechanisms used to store such multiple V3C parameter sets information and multiple V3C unit headers information in a file (e.g., an ISOBMFF file), for example, if multiple V3C parameter sets information and/or multiple V3C unit headers information is changing over the time and/or the association between samples (e.g., each sample) present in a track and its associated V3C parameter set and V3C unit header information.

Details on storage of multiple parameter sets (e.g., V3C parameter sets) information may be provided. If a bitstream (e.g., V3C bitstream) has more than one parameter set (e.g., V3C parameter set), details on their storage are provided. Details on how the mapping between a sample and its associated parameter set (e.g., V3C parameter set), and unit header information (e.g., V3C unit header information) is signaled in a file (e.g., an ISOBMFF file) is also provided.

Features are described herein for allowing multiple instances of SampleEntry in a V3C bitstream track, atlas track or atlas tile track, V3C video tracks to store multiple V3C parameter sets and multiple V3C Unit headers information.

Features are described herein for providing a (e.g., new) VPS information sample group with a grouping_type equal to ‘vvps’ and the corresponding SampleGroupDecsriptionEntry with the same grouping in V3C atlas tracks, V3C atlas tile tracks, V3C bit stream track or the video component tracks to signal or store the multiple V3C parameter sets and V3C unit headers present in a V3C bitstream.

Features are described herein include mapping of a sample and its associated VPS and V3C unit header information that may be present in a V3C atlas track, a V3C atlas tile track, a V3C bitstream track or a video component track using SampleToGroupBox and SampleGroupDecsriptionEntry boxes.

In examples, multiple sample entries may be provided. Features are described herein for a single track case or a multi-track case.

In single track examples, V3C parameter sets information may be stored using multiple sample entries in the V3C bitstream track, for example, if the V3C data is carried using single track and/or multiple V3C parameter sets are present in a V3C bitstream. Each V3C parameter set associated with one or more samples in a V3C bitstream track may be stored in a separate SampleEntry instance. Sample entries (e.g., all sample entries) present in a V3C bitstream track may be signaled in the SampleDescriptionBox of that track. Each SampleEntry in a SampleDescriptionBox may be identified using the sample_description_index. A V3C parameter set information may be stored inside the V3CConfigurationBox of a sample entry instance. The group of samples in a V3C bitstream track that refers to a V3C parameter set, may use the corresponding sample_description_index value in the SampleToChunkBox for those samples.

In muti-track examples, V3C parameter sets information may be stored using multiple sample entries in the V3C atlas track, for example, if the V3C data is carried using multiple tracks and multiple V3C parameter sets are present in a V3C bitstream. Each V3C parameter set associated with one or more samples in a V3C atlas track may be stored in a separate SampleEntry instance. Each sample entry (e.g., all sample entries) present in a V3C atlas track may be stored in the SampleDescriptionBox of that track. Each SampleEntry in a SampleDescriptionBox may be identified using the sample_description_index. A V3C parameter set information may be stored inside the V3CConfigurationBox and a V3C unit header information may be stored inside the V3CUnitHeaderBox of an atlas sample entry instance. The group of samples in a V3C atlas track that refer to a V3C parameter set and a V3C unit header information, may use the corresponding sample_description_index value in the SampleToChunkBox for those samples.

In multi-track examples, V3C unit header information may be stored using multiple sample entries in a video component track, for example, if the V3C data is carried using multiple tracks and multiple V3C parameter sets are present in a V3C bitstream. Each V3C unit header associated with one or more samples in a video component track may be stored in a separate SampleEntry instance (e.g., in SchemeInformationBox). All sample entries present in a video component track may be stored in the SampleDescriptionBox of that track. Each SampleEntry in a SampleDescriptionBox may be identified using the sample_description_index. A V3C unit header information may be stored inside the V3CUnitHeaderBox of a restricted video sample entry instance. The group of samples in a video component track that refer to a V3C unit header information, may use the corresponding sample_description_index value in the SampleToChunkBox for those samples.

In multi-track examples, V3CAtlasTileSampleEntry may be extended to include V3CConfigurationBox and V3CUnitHeaderBox, for example, if the V3C data is carried using tile tracks and multiple the V3C parameter sets are present in a V3C bitstream. The V3C parameter sets and V3C unit headers information may be stored using multiple sample entries in a V3C atlas tile track. Each V3C parameter set and the V3C unit header associated with one or more samples in a V3C atlas tile track may be stored in a separate SampleEntry instance. Sample entries (e.g., all sample entries) present in a V3C atlas tile track may be stored in the SampleDescriptionBox of that track. Each SampleEntry in a SampleDescriptionBox may be identified using the sample_description_index. The group of samples in a V3C atlas tile track that refers to a V3C parameter set and a V3C unit header information, may use the corresponding sample_description_index value in the SampleToChunkBox for those samples. The atlas track that may be associated with one or more atlas tile tracks may include one SampleEntry, for example, in a case where multiple VPSs may be present in a V3C bitstream. The atlas track associated with one or more atlas tile tracks may include all V3C parameter sets and all of the atlas V3C unit headers information in V3CconfigurationBox and V3CUnitHeaderBox.

The following syntax for a V3CAtlasTileSampleEntry may be provided:

```
aligned(8) class V3CAtlasTileSampleEntry( ) extends
VolumetricVisualSampleEntry (‘v3t1’) {
  V3CAtlasTileConfigurationBox tile_info;
  V3CConfigurationBox config;
  V3CUnitHeaderBox unit_header;
}
```

The V3CDecoderConfigurationRecord present in the atlas track that references the V3C atlas tile tracks may list all the V3C parameter sets present in the V3C bitstream, for example, if multiple V3C parameter sets are present in a V3C bitstream. In this case, the num_of_v3c_parameter_sets in V3CDecoderConfigurationRecord may be equal to the number of unique V3C parameter sets present in the bitstream.

If multiple V3C parameter sets are present in a V3C bitstream, the V3CAtlasTileSampleEntry may be extended to include v3c_parameter_set_index and/or v3c_unit_header_index as shown below:

```
aligned(8) class V3CAtlasTileSampleEntry( ) extends
VolumetricVisualSampleEntry (‘v3t1’) {
  V3CAtlasTileConfigurationBox tile_info;
  unsigned int(4) v3c_parameter_set_index;
  unsigned int(4) v3c_unit_header_index;
}
```

The following semantics may be provided. v3c_parameter_set_index may be an integer that gives the index of the v3c parameter set that is referred by the samples. The index may range from 1 to the number of V3C parameter sets present in the V3CconfigurationBox. For ‘v3t1’ track types, this value may represent the index of the V3C parameter sets present in the V3CconfigurationBox of the associated atlas track. v3c_unit_header_index may be an integer that gives the index of the v3c unit header that is used by the samples. The index may range from 1 to the number of V3C unit headers present in the V3CUnitHeaderBox. For ‘v3t1’ track types, this value may represent the index of the V3C unit headers present in the V3CUnitHeaderBox of the associated atlas track. The V3CUnitHeaderBox present in the atlas base track that is associated with all the atlas tile tracks, may be extended to include unique atlas V3C unit headers (e.g., all unique atlas V3C unit headers).

```
aligned(8) class V3CUnitHeaderBox extends FullBox(‘vunt’,
version = 0, 0){
  unsigned int(8) num_v3c_unit_headers;
    for (int i=0; i < num_v3c_unit_headers; i++) {
      v3c_unit_header header( ); // (e.g., 4-bytes)
  }
}
```

In example, multiple atlas tracks may be provided. V3C unit headers information may be stored using multiple sample entries in the V3C atlas track, for example, if the V3C data with multiple atlases is carried using multiple atlas tracks and multiple V3C parameter sets are present in the V3C bitstream. Each V3C unit header information associated with one or more samples in a V3C atlas track may be stored in a separate SampleEntry instance. All sample entries present in a V3C atlas track (‘v3a1’ or ‘v3ag’) may be stored in the SampleDescriptionBox of that track. Each SampleEntry in a SampleDescriptionBox is identified using the sample_description_index. One (e.g., only one) instance of V3C unit header information may be stored inside the V3CUnitHeaderBox of an atlas sample entry instance. The group of samples in a V3C atlas track that refers to a V3C unit header information, may use the corresponding sample_description_index value in the SampleToChunkBox for those samples. The V3C atlas base track with sample entry type ‘v3cb’ may include (e.g., only) one SampleEntry, for example, if/when multiple V3C parameter sets may be present in the V3C bitstream. The V3CconfigurationBox present in the V3C atlas base track with sample entry type ‘v3cb’ may list all the V3C parameter sets present in the bitstream.

The following syntax may be provided for a V3CAtlasSampleEntry:

```
aligned(8) class V3CAtlasSampleEntry( ) extends
VolumetricVisualSampleEntry (type) {
    // type is ‘v3a1’, or ‘v3ag’
    V3CConfigurationBox config;
    V3CUnitHeaderBox unit_header;
    unsigned int(1) VPS_index_present;
    if(VPS_index_present) {
      unsigned int(4) v3c_parameter_set_index;
      unsigned int(3) reserved {0};
    }
    else {
      unsigned int(7) reserved {0};
    }
  }
```

The following semantics may be provided. VPS_index_present may indicate whether V3C parameter set index is present or not. If VPS_index_present is set to 1, it may indicate that the bitstream has multiple V3C parameter sets and/or the VPS index is signaled in the atlas sample entry. If VPS_index_present is set to 0, it may indicate the VPS index is not signaled in the atlas sample entry. For tracks with sample entry type ‘v3c1’, ‘v3cg’, ‘v3cb’, this value may be set to 0. v3c_parameter_set_index is an integer that may provide the index of the v3c parameter set that is referred by the samples. The index may range from 1 to the number of V3C parameter sets present in the V3CconfigurationBox. For ‘v3a1’ or ‘v3ag’ track types, this value may represent the index of the V3C parameter set present in the V3CconfigurationBox of the associated ‘v3cb’ track. For all other track types, this value may be set to 0.

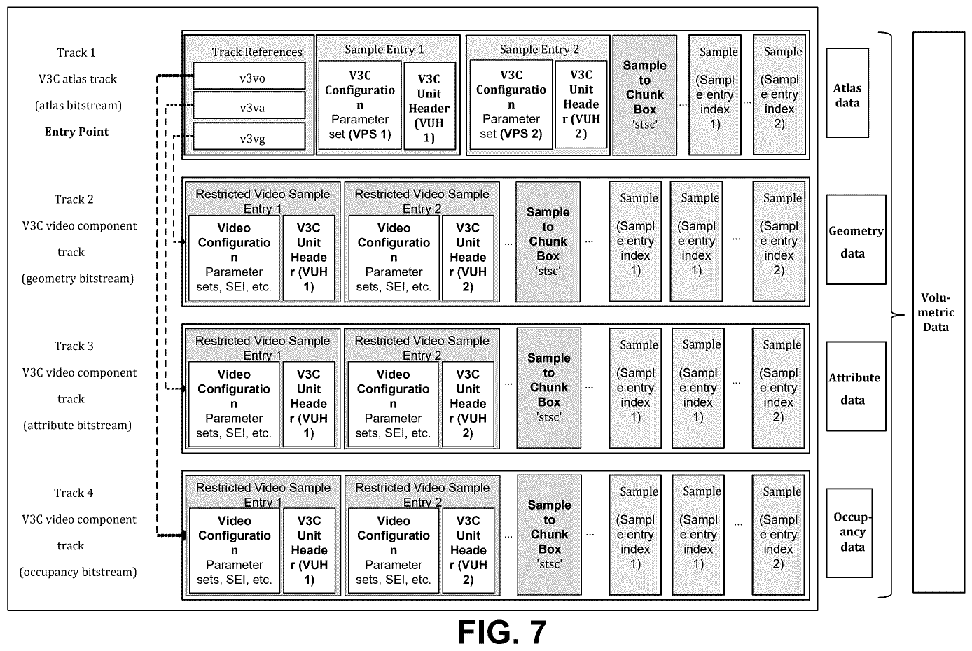

Features are described herein regarding an extraction process in case of a multi-track with single atlas track. FIG. 7 illustrates an example of using multiple sample entries in multi-track V3C file. FIG. 7 may illustrate an example of a V3C ISOBMFF file structure with one atlas track and three video component tracks. As illustrated in FIG. 7, Track 1 may be an atlas track comprising multiple sample entries. The sample entry 1 in Track 1 may include a V3CConfigurationBox including one V3C parameter set referred as VPS1 and a V3CUnitHeaderBox including one V3C Unit header information referred as VUH1. Sample entry 2 may include V3C parameter set VPS2 and V3C Unit header information VUH2 in the respective boxes.

If multiple V3C parameters are present in a V3C bitstream, the samples in Track 1 using the V3C parameter set VPS1 and V3C Unit header information VUH1 (e.g., stored in Sample Entry 1, as shown in FIG. 7) may be identified using the sample_description_index value in the SampleToChunkBox which is set to 1. The samples in Track 1 using the V3C parameter set VPS2 and V3C Unit header information VUH2 (stored in Sample Entry 2, as shown in FIG. 7) may be identified using the sample_description_index value in the SampleToChunkBox which is set to 2.

In examples, VPS information sample grouping may be provided. In examples, V3CconfigurationBox may signal (e.g., all) V3C parameter sets that are present in the V3C bitstream, for example, if multiple V3C parameter sets are present in a V3C bitstream. In examples, V3CconfigurationBox may carry (e.g., only) one V3C parameter set that is used for the 1^{st} sample present in the V3C atlas track or the 1^{st} sample present in the associated V3C atlas tile tracks, for example, if multiple V3C parameter sets are present in a V3C bitstream. The sample group description entries in sample group description box with grouping_type equal to ‘vvps’ may carry the V3C parameter sets and the V3C unit headers information.

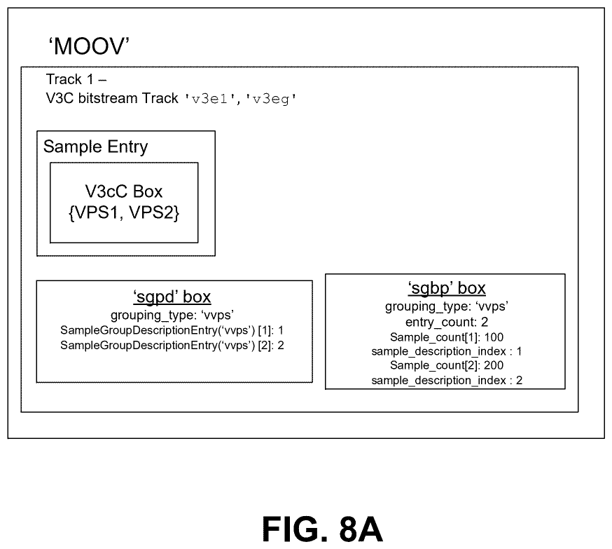

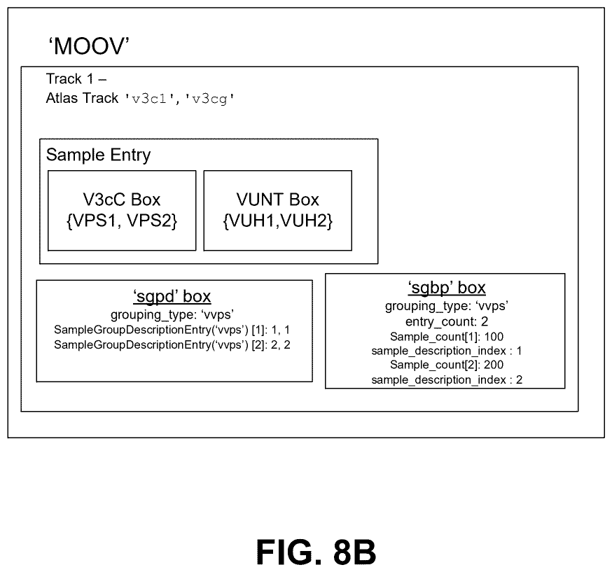

FIG. 8A shows an example of a V3C ISOBMFF file structure with a single track. In examples with a single track, the V3C parameter set information related to one or more samples present in that V3C bitstream track may be signaled using the VPS information sample group with a grouping_type equal to ‘vvps’, for example, if the V3C data is carried using single track and multiple V3C parameter sets are present in the V3C bitstream. The VPS information sample group with grouping type ‘vvps’ may be used to group the V3C samples that use the same V3C parameter set information in a V3C bitstream track.

8B shows an example of a V3C ISOBMFF file structure with a single atlas track. In examples with a single atlas track, the V3C parameter set information, and the V3C unit header information related to the samples present in that atlas track may be signaled using the VPS information sample group with a grouping_type equal to ‘vvps’, for example, if the V3C data is carried using multiple tracks and multiple V3C parameter sets are present in the V3C bitstream. The VPS information sample group with a grouping type ‘vvps’ may be used to group the V3C atlas samples that use the same V3C parameter set information in a V3C atlas track.

In examples with an atlas tile track, the V3C parameter set information and the V3C unit header information related to the samples present in that atlas tile track may be signaled using the VPS information sample group with a grouping_type equal to ‘vvps’, for example, if the V3C data is carried using multiple tracks and multiple V3C parameter sets are present in the V3C bitstream. If atlas tile tracks are present, the associated atlas track may not include any sample to group box and sample group description box with a grouping_type equal to ‘vvps’. The VPS information sample group with a grouping type ‘vvps’ may be used to group the V3C atlas tile samples that use the same V3C parameter set information which is present in the associated V3C atlas tile track.

In examples with multiple atlas tracks, the V3C parameter set information, and the V3C unit header information related to the samples present in that atlas tile track may be signaled using the VPS information sample group with a grouping_type equal to ‘vvps’, for example, if the V3C data with multiple atlases is carried using multiple atlas tracks and multiple V3C parameter sets are present in the V3C bitstream. If multiple atlas tracks are present, the associated atlas base track may not include any sample to group box and sample group description box with a grouping_type equal to ‘vvps’. Under the ‘v3a1’ and ‘v3ag’ sample entry, no V3C parameter set shall be stored in the v3c_parameter_set array.

In video component tracks, the video component track may include sample to group box and sample group description box with a grouping_type equal to ‘vvps’, for example, if the V3C data is carried using an atlas track and video component tracks, and multiple V3C parameter sets are present in the V3C bitstream. The V3C unit headers information may be signaled in the V3CUnitHeaderBox. The RestrictedSchemeInfoBox may include a V3CUnitHeaderBox. V3C parameter set information required for a sample present in a video component track may get that information from the associated sample in the atlas track.

In examples, sample group and sample group description may be provided. The use of ‘vvps’ for the grouping_type in sample grouping may represent the assignment of samples in a V3C track to the corresponding V3C parameter set and the V3C unit header carried in the SampleGroupDescriptionEntryBox. In examples, an accompanying SampleGroupDescriptionBox with the same grouping type may be present and SampleToGroupBox may include the index of the sample group description entry that the sample belongs to. Group Types may include ‘vvps’, for example, if a SampleToGroupBox with grouping_type equal to ‘vvps’ is present. A container may include Sample Group Description Box (‘sgpd’). It may not be mandatory. The quantity may be zero or one.

| | |
|---|---|
| Group Types: | ‘vvps' |
| Container: | Sample Group Description Box (‘sgpd’) |
| Mandatory: | No |
| Quantity: | Zero or one |

A VPS information sample group entry may include a v3c parameter set and a v3c Unit header information for the atlas samples that use the same v3c parameter set information. A VPS information sample group entry may define the V3C parameter set information for the samples in a V3C bitstream track that use the same V3C parameter set information. If multiple V3C parameter sets are present in the V3C bitstream, the sample grouping type ‘vvps’ may be used in tracks with the sample entries ‘v3e1’, ‘v3eg’, ‘v3c1’, ‘v3cg’, ‘v3t1’, ‘v3a1’ or ‘v3ag’. This sample group and the associated sample group description entries may be present in a V3C bitstream track, V3C atlas tracks or V3C atlas tile tracks only if multiple V3C parameter sets are present in a V3C bitstream. If the multiple V3C parameter sets are not available in the V3C bitstream, this information is available in V3CConfigurationBox, and this sample group and the associated sample group description entries may not be present in any V3C track. If multiple V3C parameter sets are present in the V3C bitstream, the sample grouping type ‘vvps’ may be present in V3C video component tracks.

In examples, num_of_v3c_parameter_sets in a V3CDecoderConfigurationRecord may be equal to the number of unique V3C parameter sets present in a bitstream (e.g., a V3C bitstream).

The syntax of the V3CParameterSetInfoEntry may be as follows. Under the ‘v3a1’ and ‘v3ag’ sample entry, num_of_v3c_parameter_sets may be equal to 0. The V3C parameter sets may be stored in the V3CDecoderConfigurationRecord of the associated ‘v3cb’ track.

The syntax of the V3CParameterSetInfoEntry may be as follows:

```
For ‘v3c1’, ‘v3cg’, ‘v3t1’,‘v3a1’ or ‘v3ag’ track types,
aligned(8) class V3CParameterSetInfoEntry( ) extends
VolumetricVisualSampleGroupEntry (‘vvps’)
{
  unsigned int(4) V3c_parameter_set_index;
  unsigned int(4) v3c_unit_header_index;
}
For ‘v3e1’, ‘v3eg’ track types,
aligned(8) class V3CParameterSetInfoEntry( ) extends
VolumetricVisualSampleGroupEntry (‘vvps’)
{
  unsigned int(4) V3c_parameter_set_index;
  unsigned int(4) reserved = 0;
}
For video component track types,
aligned(8) class V3CParameterSetInfoEntry( ) extends
VolumetricVisualSampleGroupEntry (‘vvps’)
{
  unsigned int(4) v3c_unit_header_index;
  unsigned int(4) reserved = 0;
}
The V3CUnitHeaderBox may include (e.g., all) the V3C unit headers
that refer to the available V3C parameter sets.
aligned(8) class V3CUnitHeaderBox extends FullBox(‘vunt’,
version = 0, 0){
  unsigned int(5) num_of_v3c_parameter_sets;
    for (int i=0; i < num_of_v3c_parameter_sets; i++) {
      v3c_unit_header header( ); // (e.g., 4-bytes)
  }
}
In examples, the syntax of the V3CParameterSetInfoEntry may be as
follows:
For ‘v3c1’, ‘v3cg’, ‘v3t1’,‘v3a1’ or ‘v3ag’ track types,
aligned(8) class V3CParameterSetInfoEntry( ) extends
VolumetricVisualSampleGroupEntry (‘vvps’)
{
  V3CConfigurationBox config;
  V3CUnitHeaderBox unit_header;
}
For ‘v3e1’, ‘v3eg’ track types,
aligned(8) class V3CParameterSetInfoEntry( ) extends
VolumetricVisualSampleGroupEntry (‘vvps’)
{
  V3CConfigurationBox config;
}
For video component track types,
aligned(8) class V3CParameterSetInfoEntry( ) extends
VolumetricVisualSampleGroupEntry (‘vvps’)
{
  V3CUnitHeaderBox unit_header;
}
```

V3c_parameter_set_index may be an integer that indicates the index of the v3c parameter set that is referred to by the samples. The index may range from 1 to the number of V3C parameter sets present in the V3CconfigurationBox. For ‘V3a1’ or ‘v3ag’ track types, this value may represent the index of the V3C parameter sets present in the V3CconfigurationBox of the associated ‘v3cb’ track. For ‘v3t1’ track types, this value may represent the index of the V3C parameter sets present in the V3CconfigurationBox of the associated atlas track.

v3c_unit_header_index may be an integer that indicates the index of the v3c unit header that is used by the samples. The index may range from 1 to the number of V3C unit headers present in the V3CUnitHeaderBox. This value may be set to zero for V3C bitstream tracks with sample entry type ‘v3e1’, and ‘v3eg’. For ‘v3t1’ track types, this value may represent the index of the V3C unit headers present in the V3CUnitHeaderBox of the associated atlas track. For V3C video component tracks, this value may represent the index of the V3C header information present in the SchemeInformationBox.

Features are described herein for extraction process in following cases: a single track case; a multi-track with a single atlas case; a multi-track with atlas tile tracks, and a multi-track with multiple atlas tracks.

As illustrated in FIG. 8A, Track 1 may be a V3C bitstream track including a sample group description box and sample to group box with grouping type ‘vvps’. The sample group description box with grouping_type equal to ‘vvps’ present in Track 1 may include the different V3C parameter sets information used in different samples of that track. The sample to group box with grouping_type equal to ‘vvps’ may include associated sample group description entry index for each sample present in that track.

If multiple V3C parameter sets are present in a V3C bitstream, the index of the V3C parameter set stored in V3CConfigurationBox may be carried in a sample group description entry and the samples using that V3C parameter set are indicated in the sample to Group box with grouping_type equal to ‘vvps’.

In the example shown in FIG. 8A, the sample group entry description at index 1 may specify that, the samples from 1 to 100 may use the V3C parameter set at index 1 present in the V3CconfigurationBox (e.g., V3cC box shown in FIG. 8A). The sample group entry description at index 2 may specify that the samples from 101 to 300 may use the V3C parameter set at index 2 present in the V3CconfigurationBox (V3cC box shown in FIG. 8A).

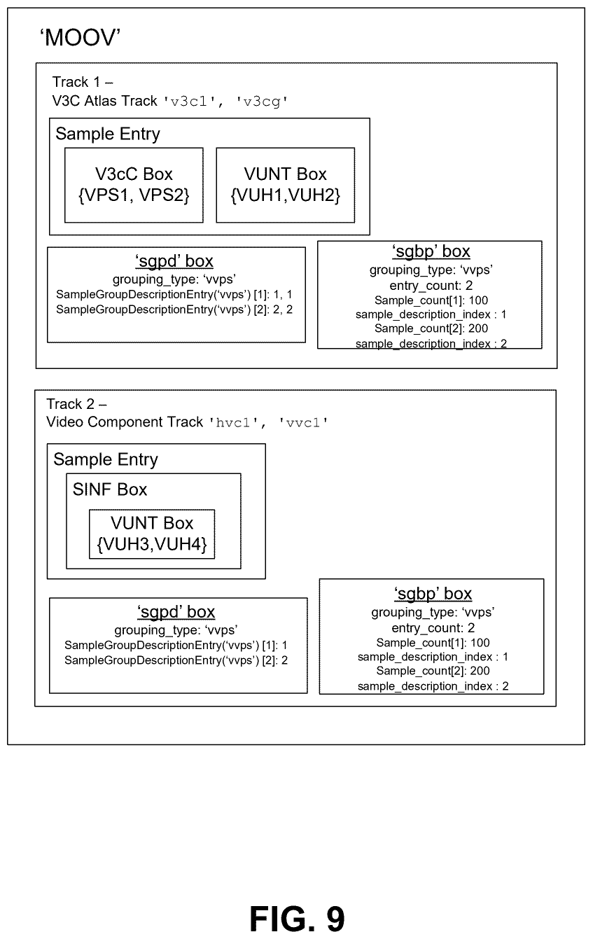

FIG. 9 may illustrate an example of using ‘vvps’ sample group in multi-track V3C file. FIG. 9 may illustrate an example of V3C ISOBMFF file structure with one atlas track and a video component track. Track 1 may be an atlas track and Track 2 may be a video component track. An atlas track may include the sample group description box and sample to group box with grouping type ‘vvps’. The sample group description box with grouping_type equal to ‘vvps’ present in Track 1 may signal the different V3C parameter sets used in different samples of that track. The sample to group box with grouping_type equal to ‘vvps’ may include an associated sample group description entry index for each sample present in that track.

If multiple V3C parameters are present in a V3C bitstream, the index of the V3C parameter set stored in V3CConfigurationBox and the index of the V3C unit header information stored in V3CUnitHeaderBox may be signaled in a sample group description entry and the samples using that V3C parameter set may be indicated in the sample to group box with grouping_type equal to ‘vvps’. In the example shown in FIG. 9, samples from 1 to 100 in Track 1 may fetch the information about V3C parameter set from sample group entry description at index 1. In the example shown in FIG. 9, the sample group entry description at index 1 may specify that the samples from 1 to 100 may use the V3C parameter set at index 1 present in the V3CconfigurationBox (V3cC box shown in FIG. 9). The samples from 1 to 100 may use the V3C unit header information at index 1 present in the V3CUnitHeaderBox (VUNT box shown in FIG. 9).

The sample group entry description at index 2 may specify that the samples from 101 to 300 may use the V3C parameter set at index 2 present in the V3CconfigurationBox (V3cC box shown in FIG. 9) and the V3C unit header information at index 2 present in the V3CUnitHeaderBox (VUNT box shown in FIG. 9).

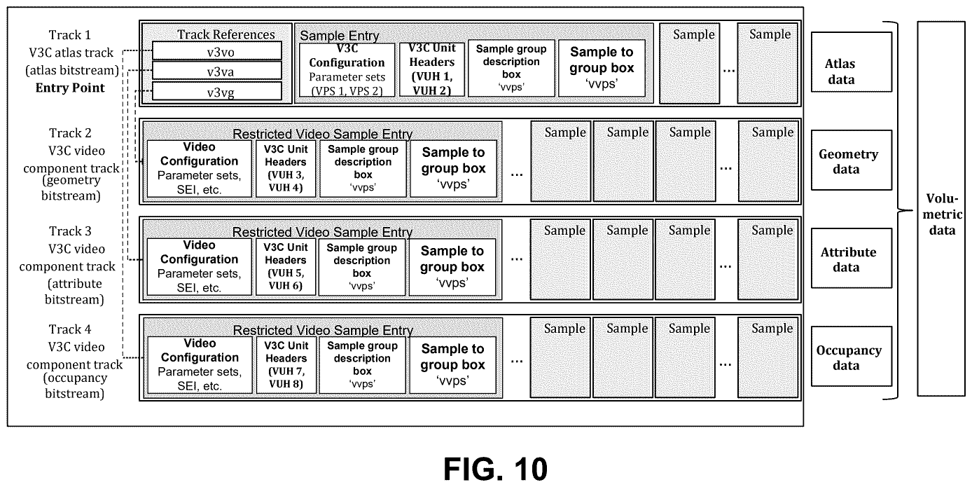

In a video component track (e.g., Track 2), the index of the V3C unit header information stored in V3CUnitHeaderBox may be signaled in a sample group description entry and the samples using that V3C unit header information may be indicated in the sample to group box with grouping_type equal to ‘vvps’. In Track 2 of the example shown in FIG. 9, the sample group entry description at index 1 may specify that, the samples from 1 to 100 may use the V3C unit header information at index 1 present in the V3CUnitHeaderBox (as shown in FIG. 9 Track 2 VUNT box). The samples from 101 to 200 in Track 2 may use the V3C unit header information at index 2 present in the V3CUnitHeaderBox. The samples from 1 to 100 in Track 2 may fetch the V3C parameter set information from the corresponding atlas sample present in Track 1. FIG. 10 may illustrate an example representation of using ‘vvps’ sample group in multi-track V3C file.

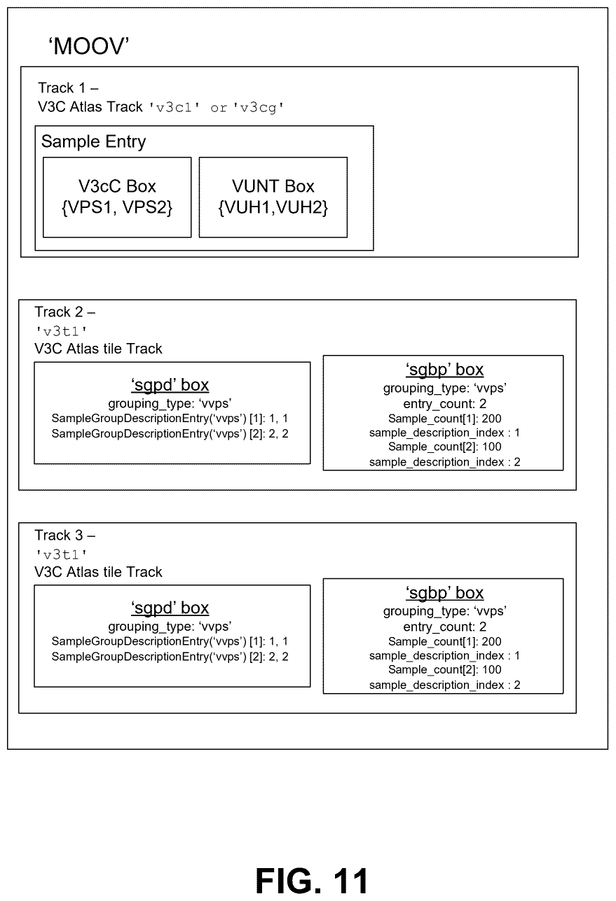

FIG. 11 illustrates an example of V3C ISOBMFF file structure with an atlas track and two atlas tile tracks. FIG. 11 illustrates an example of using ‘vvps’ sample group in a V3C file with an atlas track and multiple atlas tile tracks. Track 1 may be an atlas track and Tracks 2 and 3 may be atlas tile tracks. This atlas track may not include any sample to group box with grouping type equal to ‘vvps’ and the associated sample group description box. The atlas tile tracks may include the sample to group box with grouping type equal to ‘vvps’ and the associated sample group description box. The sample group description box with grouping_type equal to ‘vvps’ present in Track 2 may signal the different V3C parameter sets, and V3C unit headers information used in different samples of that track. The sample to group box with grouping_type equal to ‘vvps’ may include associated sample group description entry index for each sample present in that track. Track 3 (another atlas tile track) may include the sample group description box and sample to group box with grouping type equal to ‘vvps’.

If multiple V3C parameter sets are present in a V3C bitstream, the index of the V3C parameter set stored in V3CConfigurationBox and the index of the V3C unit header stored in the V3CUnitHeaderBox may be carried in a sample group description entry and the samples using that V3C parameter set and V3C unit header information are indicated in the sample to Group box with grouping_type equal to ‘vvps’.

In the example shown in FIG. 11, in Track 2, the sample group entry description at index 1 may specify that, the samples from 1 to 200 may use the V3C parameter set at index 1 present in the V3CconfigurationBox of the Atlas track (V3cC box shown in Track 1 of FIG. 11). The samples from 1 to 200 may use the V3C unit header information at index 1 present in the V3CUnitHeaderBox of the Atlas track (VUNT box shown in Track 1 of FIG. 11).

The sample group entry description at index 2 may specify that, the samples from 201 to 300 may use the V3C parameter set at index 2 present in the V3CconfigurationBox of the Atlas track (V3cC box shown in Track 1 FIG. 11) and the V3C unit header information at index 2 present in the V3CUnitHeaderBox of the Atlas track (VUNT box shown in Track 1 of FIG. 11).

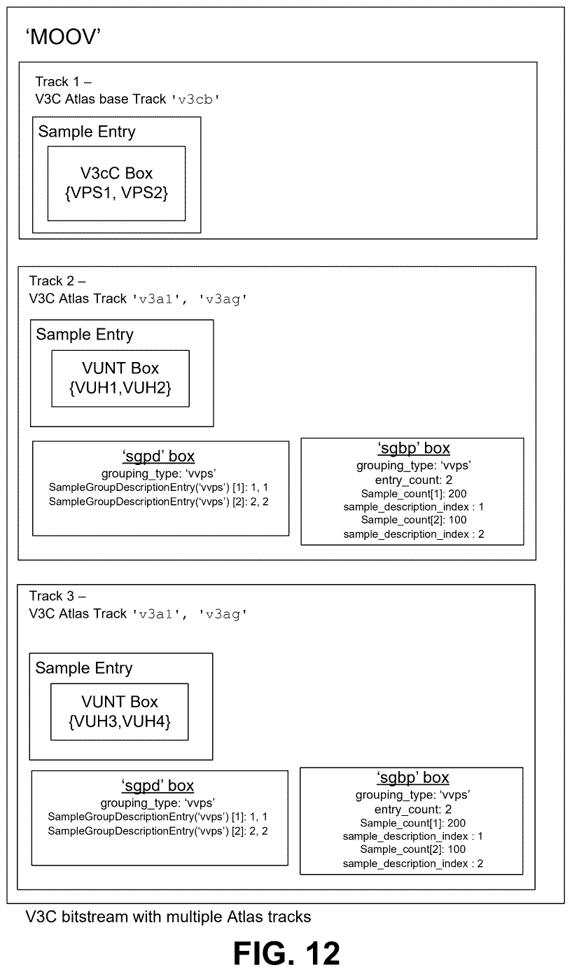

FIG. 12 illustrates an example of V3C ISOBMFF file structure with multiple atlas tracks. Track 1 may be an atlas base track and Tracks 2 and 3 may be the atlas tracks for atlas 1 and atlas 2. The atlas base track may not include any sample to group box with grouping type equal to ‘vvps’ and the associated sample group description box. The atlas tracks may include the sample to group box with grouping type equal to ‘vvps’ and the associated sample group description box. The sample group description box with grouping_type equal to ‘vvps’ present in Track 2 may signal different V3C parameter sets and/or V3C unit headers information used in different samples of that track. The sample to group box with grouping_type equal to ‘vvps’ may include an associated sample group description entry index for each sample present in that track. Track 3 (e.g., another atlas track) may include the sample group description box and sample to group box with grouping type equal to ‘vvps’.

If multiple V3C parameter sets are present in a V3C bitstream, the index of the V3C parameter set stored in V3CConfigurationBox and the index of the V3C unit header stored in the V3CUnitHeaderBox may be carried in a sample group description entry and the samples using that V3C parameter set, and V3C unit header information may be indicated in the sample to Group box with grouping_type equal to ‘vvps’.

In the example shown in FIG. 12, in Track 2, the sample group entry description at index 1 may specify that the samples from 1 to 200 may use the V3C parameter set at index 1 present in the V3CconfigurationBox of the atlas base track (V3cC box shown in Track 1 of FIG. 12). The samples from 1 to 200 may use the V3C unit header information at index 1 present in the V3CUnitHeaderBox of that Atlas track (VUNT box shown in Track 2 of FIG. 12).

In Track 2, the sample group entry description at index 2 may specify that, the samples from 201 to 300 may use the V3C parameter set at index 2 present in the V3CconfigurationBox of the atlas base track (V3cC box shown in Track 1 FIG. 12) and the V3C unit header information at index 2 present in the V3CUnitHeaderBox of that atlas track (VUNT box shown in Track 2 of FIG. 12). FIG. 12 may illustrate an example of using ‘vvps’ sample group in a V3C ISOBMFF file with multiple atlases.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. Video data (e.g., a bitstream) that may include one or more of the described syntax elements, or variations thereof, whether transmitted, stored, or otherwise made available.
iii. Creating, storing, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. The present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings are thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment).

Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A computing system, comprising:
a processor configured to:
generate a visual volumetric video-based coding (V3C) bitstream comprising data associated with a first track and at least a first V3C parameter set and a second V3C parameter set, wherein the data comprises a plurality of samples;
store the first V3C parameter set in a first SampleEntry instance;
store the second V3C parameter set in a second SampleEntry instance;
store in a first SampleDescriptionBox associated with the first track, the first SampleEntry instance and the second SampleEntry instance;
associate, in a SampleToGroupBox, each sample of the plurality of samples with a respective sample group description entry index corresponding to a SampleGroupDescriptionEntry, wherein the SampleGroupDescriptionEntry specifies whether the first SampleEntry instance or the second SampleEntry instance is to be applied to that sample; and
send, in the V3C bitstream, the data associated with the first track, the first SampleDescriptionBox, and the SampleToGroupBox.

2. The computing system of claim 1, wherein the first track is one of a V3C bitstream track, an Atlas track, an Atlas tile track, or a V3C video component track.

3. The computing system of claim 1, wherein the V3C bitstream further comprises first V3C unit header information and second V3C unit header information, wherein the processor is further configured to:
store the first V3C unit header information in the first SampleEntry instance; and
store the second V3C unit header information in the second SampleEntry instance.

4. The computing system of claim 1, wherein a first plurality of the samples is associated with the first SampleEntry instance via a first SampleGroupDescriptionEntry, and a second plurality of the samples is associated with the second SampleEntry instance via a second SampleGroupDescriptionEntry.

5. The computing system of claim 4, wherein the data associating the first plurality of the samples with the first SampleEntry instance comprises a first sample group description entry index in the SampleToGroupBox that identifies the first SampleGroupDescriptionEntry being associated with the first SampleEntry instance, and wherein the data associating the second plurality of the samples with the second SampleEntry instance comprises a second sample group description entry index in the SampleToGroupBox that identifies the second SampleGroupDescriptionEntry being associated with the second SampleEntry instance.

6. The computing system of claim 5, wherein each SampleGroupDescriptionEntry specifies a sample description index value corresponding to a SampleEntry instance.

7. A computing system, comprising:
a processor configured to:
receive a visual volumetric video-based coding (V3C) bitstream, the V3C bitstream comprising data associated with a first track, a first SampleDescriptionBox associated with the first track, and a SampleToGroupBox associated with the first track;
retrieve from the first SampleDescriptionBox a first SampleEntry instance and a second SampleEntry instance;
retrieve from the first SampleEntry instance a first V3C parameter set;
retrieve from the second SampleEntry instance a second V3C parameter set;
for each sample of the first track, obtain a respective sample group description entry index from the SampleToGroupBox and identify a SampleGroupDescriptionEntry corresponding to the sample group description entry index, wherein the SampleGroupDescriptionEntry specifies whether the first SampleEntry instance or the second SampleEntry instance is to be applied to that sample; and
process at least one sample of the first track in accordance with the sample group description entry index obtained from the SampleToGroupBox.

8. The computing system of claim 7, wherein the processor is further configured to:
retrieve from the first SampleEntry instance a first V3C unit header information, and retrieve from the second SampleEntry instance a second V3C unit header information; and
wherein the processor is configured to render data based on at least the first V3C unit header information, the second V3C unit header information.

9. The computing system of claim 7,
wherein the data associated with the first track comprises a plurality of samples, and wherein the SampleToGroupBox comprises data associating a first plurality of the samples with the first SampleEntry instance via a first SampleGroupDescriptionEntry and data associating a second plurality of the samples with the second SampleEntry instance via a second SampleGroupDescriptionEntry.

10. The computing system of claim 9, wherein the data associating the first plurality of the samples with the first SampleEntry instance comprises a first sample group description entry index in the SampleToGroupBox that identifies the first SampleGroupDescriptionEntry being associated with the first SampleEntry instance, and wherein the data associating the second plurality of the samples with the second SampleEntry instance comprises a second sample group description entry index in the SampleToGroupBox that identifies the second SampleGroupDescriptionEntry being associated with the second SampleEntry instance.

11. A computing system, comprising:
a processor configured to:
generate a visual volumetric video-based coding (V3C) bitstream, the V3C bitstream comprising data associated with a first track and two or more of a first V3C parameter set, a second V3C parameter set, a first V3C unit header information, or a second V3C unit header information, wherein the data associated with the first track comprises a plurality of samples;
store the two or more of the first V3C parameter set, the second V3C parameter set, the first V3C unit header information, or the second V3C unit header information, in a first SampleEntry instance, wherein the first SampleEntry instance is associated with the first track;
store a SampleToGroupBox in the first track identifying, for each sample of the first track, which of the first V3C parameter set, the second V3C parameter set, the first V3C unit header information, or the second V3C unit header information stored in the first SampleEntry instance is to be applied to that sample; and
send the data associated with the first track, the first SampleEntry instance, and the SampleToGroupBox.

12. The computing system of claim 11, wherein the SampleToGroupBox indicates that a first plurality of the samples is associated with the first V3C parameter set and a second plurality of the samples is associated with the second V3C parameter set.

13. The computing system of claim 11, wherein the SampleToGroupBox indicates that a first plurality of the samples is associated with the first V3C unit header information and a second plurality of the samples is associated with the second V3C unit header information.

14. The computing system of claim 13, wherein the SampleToGroupBox indicates that the first plurality of the samples are associated with a first entry of a SampleDescriptionBox and the second plurality of the samples are associated with a second entry of the SampleDescriptionBox.

15. The computing system of claim 14, wherein each entry of the SampleDescriptionBox is associated with a respective one of the two or more of the first V3C parameter set, the second V3C parameter set, the first V3C unit header information, or the second V3C unit header information stored in the first SampleEntry instance.

16. The computing system of claim 14, wherein the SampleToGroupBox the SampleDescriptionBox are associated with a grouping type, and wherein the grouping type is vvps.

17. The computing system of claim 11, wherein the V3C bitstream further comprises data associated with a second track, the data associated with the second track comprising a plurality of second samples;
wherein the processor is further configured to:
store, in a second SampleEntry instance associated with the second track, data associating a first plurality of the second samples with the first V3C parameter set and the first V3C unit header information;
store in the second SampleEntry instance, data associating a second plurality of the second samples with the second V3C parameter set and the second V3C unit header information; and
store a second SampleToGroupBox in the second track, the second SampleToGroupBox indicating for each of the second samples, whether the sample is associated with the first V3C parameter set and the first V3C unit header information or with the second V3C parameter set and the second V3C unit header information.

18. A computing system comprising:
a processor configured to:
receive a V3C bitstream, data associated with a first track, and a first SampleEntry instance associated with the first track, wherein the data associated with the first track comprises a plurality of samples;
retrieve, from the first SampleEntry instance, two or more of: a first V3C parameter set, a second V3C parameter set, a first V3C unit header information, or a second V3C unit header information;
retrieve a SampleToGroupBox associated with the first track, the SampleToGroupBox identifying, for each sample of the first track, which of the first V3C parameter set, the first V3C unit header information, the second V3C parameter set, or the second V3C unit header information stored in the first SampleEntry instance is to be applied to that sample; and
process at least one sample of the first track using at least one of the first V3C parameter set, the first V3C unit header information, the second V3C parameter set, or the second V3C unit header information, specified via the SampleToGroupBox associated with the first track.

19. The computing system of claim 18, wherein the SampleToGroupBox indicates that a first plurality of the samples is associated with the first V3C parameter set and a second plurality of the samples is associated with the second V3C parameter set.

20. The computing system of claim 18, wherein the SampleToGroupBox indicates that a first plurality of the samples is associated with the first V3C unit header information a second plurality of the samples is associated with the second V3C unit header information.
